(19) United States
(12) Patent Application Publication
(10) Pub. No.: US 2021/0326905 A1
(43) Pub. Date: Oct. 21, 2021

(54) SYSTEM AND METHOD FOR PRODUCT AUTHENTICATION USING A BLOCKCHAIN

(71) Applicant: TRU Authentication Inc., West Palm Beach, FL (US)

(72) Inventor: Daniel McKinnon, Wayland, MA (US)

(21) Appl. No.: 17/233,214

(22) Filed: Apr. 16, 2021

Related U.S. Application Data
(60) Provisional application No. 63/011,088, filed on Apr. 16, 2020.

(51) Int. Cl. G06Q 30/00; H04L 9/06; G06Q 20/06

(52) U.S. Cl. CPC G06Q 30/0185; H04L 9/0618; H04L 2209/56; H04L 2209/38; G06Q 20/065

(57) ABSTRACT

Systems and methods for product authentication and management of a digital transaction during an authentication process.

### CROSS-REFERENCE TO RELATED APPLICATIONS

This application claims the benefit of, and priority to, U.S. Provisional Application Ser. No. 63/011,088, filed on Apr. 16, 2020, the disclosure of the provisional application is hereby incorporated by reference in its entirety and for all purposes.

### FIELD

The present disclosure relates generally to information security and more specifically, but not exclusively, to a system and method executed over the blockchain that requires the authentication of a product to release a payment.

### BACKGROUND

Despite several efforts to curb the production and stateside distribution of illegal counterfeit products, the market for counterfeit goods is not only thriving, but also advancing. For decades, fake handbags, for example, have been getting more realistic and there has been a rise of “super fakes.” To many, these fakes look like the real thing and users never have any reason to doubt the authenticity of the product. According to the International Trademark Association, over $460 billion worth of counterfeit goods were bought and sold in the last few years alone.

Most sales of counterfeit items occur online, which further complicates the problem. Consumers at a physical retail store can at least inspect a product before purchasing for authenticity. Online users do not have this luxury. Once a counterfeit item is purchased online, the seller can disappear or change identities. By the time the items have been exchanged, the counterfeit seller already has money in possession.

In view of the foregoing, a need exists for an improved system can provide authentication of a product during an online sale in an effort to overcome the aforementioned obstacles and deficiencies of conventional counterfeit detection systems.

### BRIEF DESCRIPTION OF THE DRAWINGS

FIG. 1 is an exemplary top-level block diagram illustrating an embodiment of a product authentication system.

FIG. 2A is an exemplary top-level block diagram illustrating another embodiment of the product authentication system of FIG. 1.

FIG. 2B is an exemplary top-level block diagram illustrating another embodiment of the product authentication system of FIG. 1.

FIG. 3A is an exemplary flow diagram illustrating one embodiment of a data flow for interfacing with the client devices of the product authentication system of FIG. 1.

FIG. 3B is an exemplary flow diagram illustrating one embodiment of a data flow for the authentication server based on the data flow for interfacing with the client devices of FIG. 3A.

FIG. 3C is an exemplary flow diagram illustrating another embodiment of a data flow for interfacing with the client devices of the product authentication system of FIG. 1.

FIG. 4A is an exemplary flow diagram illustrating another embodiment of a data flow for interfacing with the client devices of the product authentication system of FIG. 1.

FIG. 4B is an exemplary flow diagram illustrating another embodiment of a data flow for interfacing with the client devices of the product authentication system of FIG. 1.

FIG. 4C is an exemplary flow diagram illustrating another embodiment of a data flow for interfacing with the client devices of the product authentication system of FIG. 1.

FIG. 4D is an exemplary screenshot illustrating one embodiment of a user interface for logging in to an application of the product authentication system of FIG. 1.

FIG. 5A is an exemplary flow diagram illustrating another embodiment of a data flow for the authentication server based on the data flow for interfacing with the client devices of FIG. 4A.

FIG. 5B is an exemplary flow diagram illustrating one embodiment of a data flow for the ledger based on the data flow for the authentication server of FIG. 5A.

FIG. 6 is an exemplary flow diagram illustrating another embodiment of a data flow for interfacing with the client devices to authenticate the product of FIG. 1.

FIG. 7A is an exemplary flow diagram illustrating one embodiment of a data flow for the authentication server to process the claim request of FIG. 6.

FIG. 7B is an exemplary flow diagram illustrating one embodiment of a data flow for the ledger based on the processing of the claim request of FIG. 7A.

FIG. 7C is an exemplary flow diagram illustrating one embodiment of a data flow for the authentication server based on the ledger process of FIG. 7B.

FIG. 7D is an exemplary flow diagram illustrating one embodiment of a data flow for interfacing with the client devices based on the data flow of the authentication server of FIG. 7C.

FIG. 8A is an exemplary flow diagram illustrating one embodiment of a data flow for the authentication server to process the ownership transfer request of FIG. 7D.

FIG. 8B is an exemplary flow diagram illustrating one embodiment of a data flow for the client devices based on the ownership transfer request process on the authentication server of FIG. 8A.

FIG. 8C is an exemplary flow diagram illustrating another embodiment of a data flow for interfacing with the client devices based on the ownership transfer request process on the authentication server of FIG. 8A.

FIG. 8D is an exemplary flow diagram illustrating another embodiment of a data flow for the authentication server to process the ownership transfer acceptance of FIG. 8C.

FIG. 9 is an exemplary flow diagram illustrating one embodiment of a data flow for the ledger based on the processing of the ownership transfer acceptance of FIG. 8D.

FIG. 10 is an exemplary flow diagram illustrating one embodiment of a data flow for the authentication server to fulfillment of the smart contract of FIG. 9.

FIG. 11 is an exemplary flow diagram illustrating one embodiment of a data flow for the client devices based on the fulfillment of the smart contract on the authentication server of FIG. 10.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

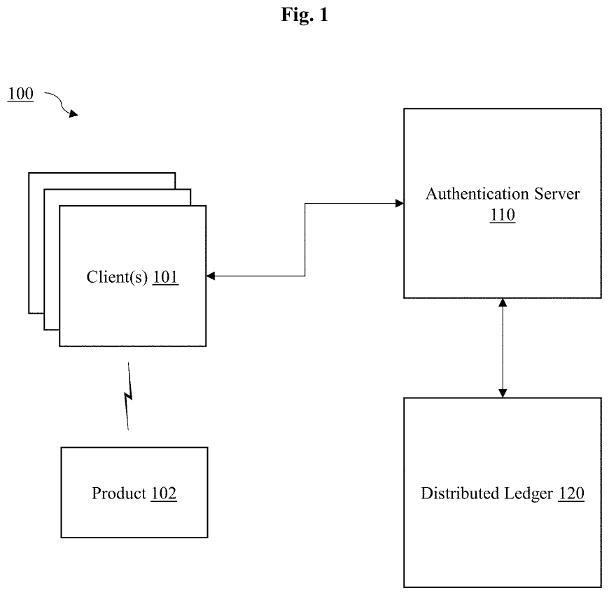

Since currently-available counterfeit detection systems are deficient because they fail to authenticate a product at an online point of sale, a product authentication system that manages a digital transaction during an authentication process can prove desirable and provide a basis for a wide range of counterfeit detection applications, such as the ability to reduce the secondary market for counterfeit sales. This result can be achieved, according to one embodiment disclosed herein, by a product authentication system 100 as illustrated in FIG. 1.

Turning to FIG. 1, the product authentication system 100 includes one or more client devices 101 in operable communication with an authentication server 110. The authentication server 110 can include one or more specialized computer systems that are individually and/or collectively configured to manage a digital transaction of a product 102 via electronic data streams. The authentication server 110 can manage digital payment methods throughout the transaction of the product 102. An exemplary authentication server 110 can receive data from a selected client device 101 and send data to one or more other client devices 101 based one predetermined criterion. In some embodiments, the authentication server 110 includes web application servers and database servers. Coded instructions of a software program can be installed on the authentication server 110 to implement the disclosed functions.

Advantageously, the methods described herein can operate over one or more ledgers 120. By way of example, the digital transaction of the product 102 can operate as a smart contract in the ledger 120 when one or more predetermined conditions are met, thereby triggering other functions (e.g., release of payment from an electronic escrow described herein). The product authentication system 100 is suitable for use with a wide range of ledgers 120, such as any immutable distributed ledger, including, for example, a public Blockchain (e.g., Bitcoin® Blockchain, Ethereum® Blockchain, etc.) and/or a private Blockchain and/or the like. In some embodiments, the ledger 120 comprises a combination of public and/or private Blockchains.

Advantageously, a Blockchain is a decentralized system that exists only between permitted parties and can enable the use of smart contracts, also known as self-executing contracts, blockchain contracts, or digital contracts. As used herein, smart contracts include all variations for transferring an asset or currency into a program or computer protocol to digitally facilitate, verify, and/or enforce the negotiation or performance of a contract without the need for a third party. The product authentication system 100 can rely on this type of ledger 120 to provide dimensions that need to be satisfied in order for a transaction to be considered fulfilled. In some embodiments, each transaction recorded to the Blockchain can represent one or more physical products, wherein a unique identifier for the one or more physical products can be issued by the Blockchain. This approach can yield various degrees of authentication of the transaction including, but not limited to, a proof of authenticity of the product, a proof of ownership of the product, a proof of shipment, a proof of reception, and so on. These exemplary proofs can be satisfied by a combination of the application and external integrations, such as a shipment service provider.

For exemplary purposes only, the ledger 120 can include an open source Blockchain, such as Algorand, a fully decentralized, secure, and scalable blockchain that provides at least a settlement layer and a smart contract layer. The product authentication system 100 can also include additional layers as desired, such as the authentication server 110 for managing the transactions between the user and the ledger 120 and the application for capturing information used to establish authenticity (e.g., NFC readings, QR/bar code readings, Bluetooth signatures, photos, GPS location, and biometrics including finger printing and facial scans).

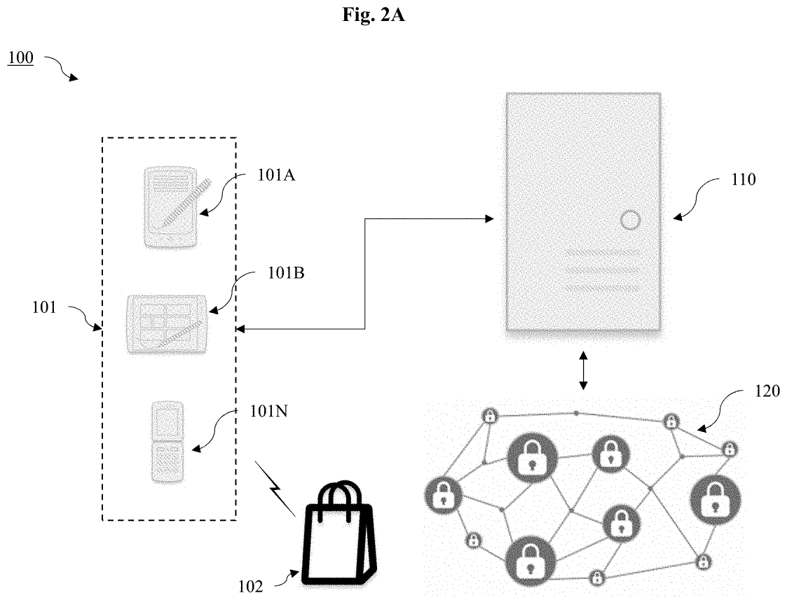

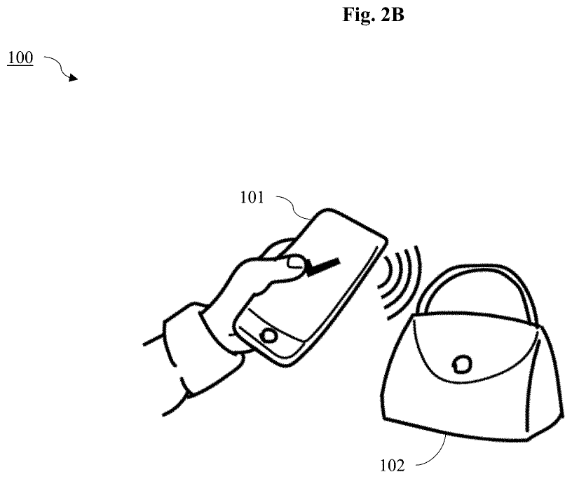

Turning to FIGS. 2A-B, a customer can scan the product 102 wirelessly using their client device 101. In FIG. 2A, the client device 101 is any network-connected device through which the customer can exchange digital information about the transaction of the product 102 with the authentication server 110. For example, the client device 101 can include any number of uniform and/or different client devices 101, illustratively shown as client devices 101A, 101B, . . . through 101N. Each client device 101 can include a specialized computer system and/or electronic device. An exemplary client device 101 can include a personal computer (PC), a mobile computer device, such as a tablet computer and/or a smart phone, a point-of-sale (POS) device, and/or the like. Coded instructions, for example, of an application (or app) can be installed on each of the client devices 101 to implement the functions described herein. Each client device also has an input for capturing digital information regarding the product 102. The digital information can include, for example, near-field communication (NFC) data, photographs, videos, geolocation, audio samples, biometrics, and other multimedia.

Additionally and/or alternatively, the digital information can include anti-counterfeit solutions, such as from Document Security Systems, Inc. of Rochester, N.Y. By way of example, such anti-counterfeit solutions are detailed and described in U.S. Pat. No. 7,982,917, entitled “Document Containing Scanning Survivable Security Features,” issued on Sep. 19, 2011, U.S. Pat. No. 8,444,181, entitled “Single-Color Screen Patterns for Copy Protection,” issued on May 21, 2013, U.S. Pat. No. 7,906,198, entitled “Document Containing Security Images,” issued on Mar. 15, 2011, U.S. Pat. No. 7,845,572, entitled “Solid-Color Embedded Security Feature,” issued on Dec. 7, 2010, U.S. Pat. No. 7,976,068, entitled “Double-Blink Security Features,” issued on Jul. 12, 2011, U.S. Pat. No. 9,372,361, entitled “Polarization Decoder,” issued on Jun. 21, 2016, U.S. Pat. No. 9,171,347, entitled “System and Method for Analysis and Authentication of Covert Security Information Using a Smart Device,” issued on Oct. 27, 2015, and U.S. Pat. No. 10,552,846, entitled “Authenticated Barcode Patterns,” issued on Feb. 4, 2020, and co-pending U.S. patent application Ser. No. 16/781,841, entitled “Authenticated Barcode Pattern,” filed on Feb. 4, 2020, and U.S. patent application Ser. No. 15/947,743, entitled “Authenticated Barcode Pattern,” filed on Feb. 4, 2020, the disclosures of each patent and application is hereby incorporated by reference in their entirety and for all purposes.

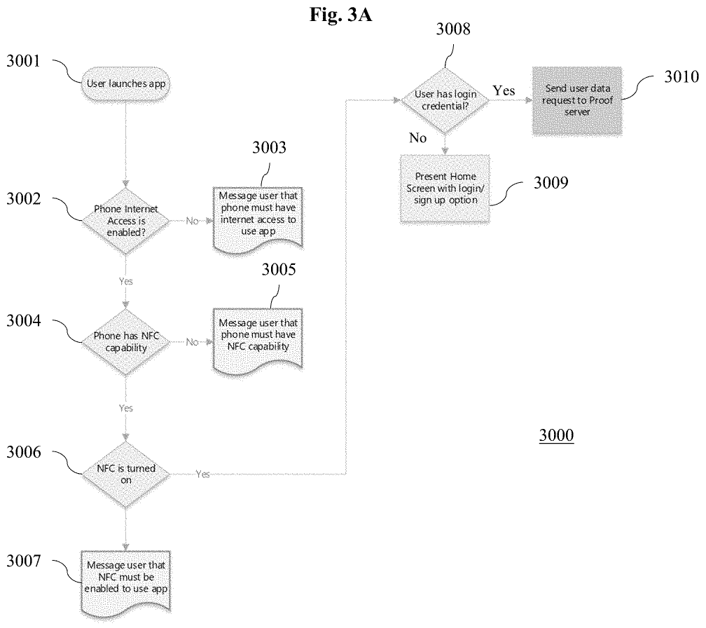

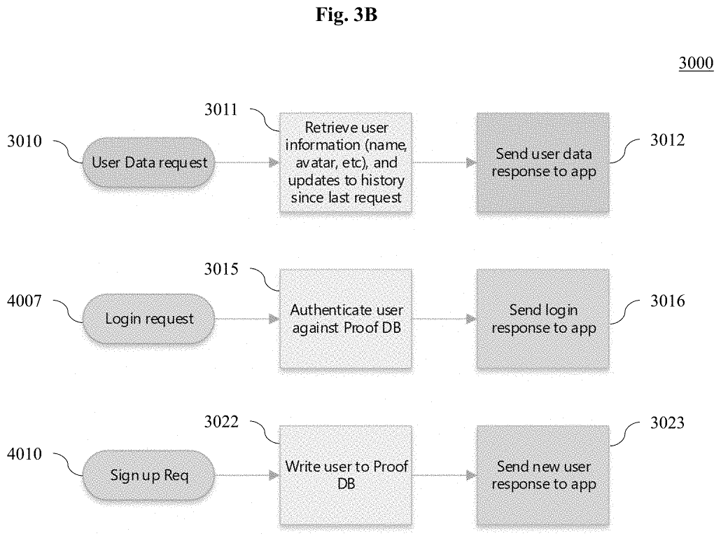

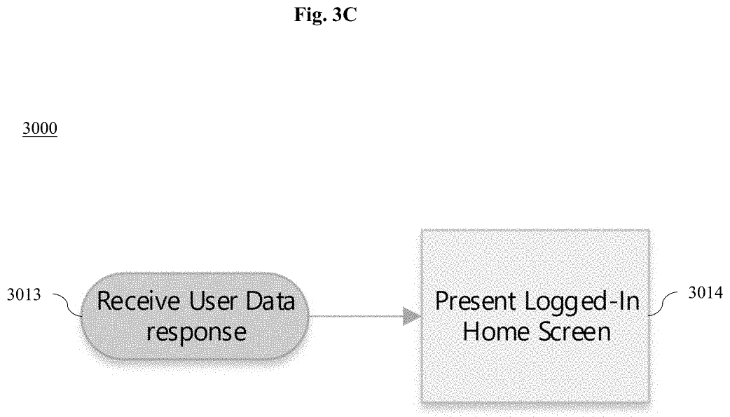

The user can interface with the app in any manner described herein, such as through an exemplary start-up process 3000, shown in FIG. 3A. With reference to FIG. 3A, the user can launch the app on their client device 101, at 3001. In some embodiments, the client device 101 must be a network-connected device to communicate with the authentication server 110 (decision block 3002). If the device cannot communicate with the authentication server 110 over a network, the client device 101 can notify the user, at 3003. In some embodiments, the client device 101 must have near-field communication (NFC) capability to scan the product 102 (decision block 3004). For example, the client device 101 can cooperate with an NFC-chip, a Bluetooth device, a Bluetooth Low Energy (BLE) device, a Bluetooth device that operates on radio frequency, a radio-frequency identification (RFID) tag, and/or a combination thereof in the product 102 to obtain a unique digital value derived from the Blockchain. In some embodiments, a combination of NFC and Bluetooth can be used to increase the range of scanning. Although described herein as an NFC-enabled device, the client device 101 can include any set of protocols that enable the device to establish communication with another apparatus within a predetermined range, such as by including application software to read electronic tags or make payments when connected to the corresponding apparatus. In other words, the client device 101 is not limited to close-range communication, but can include proximity-based technologies, for example, based on inductive coupling between devices, as desired. If the device cannot establish communication with another apparatus, for example using NFC protocols, the client device 101 can notify the user, at 3007.

Once the product authentication system 100 confirms that the client device 101 meets the minimum hardware requirements, the product authentication system 100 confirms whether the user of the client device 101 has a user account with the system 100 (decision block 3008). In some embodiments, the product authentication system 100 checks for the existence of a locally stored value issued from the server. If the user is not currently registered, an option is provided, at 3009. Alternatively, if the user wishes to log in, the client device 101 will request the corresponding user data packet from the authentication server 110, at 3010. In some embodiments, the user can provide biometrics data (e.g., fingerprint scanning, facial recognition, vocal profile), geolocation, and so on to provide an additional security layer.

At the authentication server 110, the user data request triggers a database query from a user registration database (not shown), such as shown in FIG. 3B. Turning to FIG. 3B, the user information (e.g., name, avatar, and so on) and any updates to the user history since the last user data request has been made is queried, at 3011, and returned to the client device 101, at 3012. Once the client device receives the user data response, at 3013, the client device 101 can present a logged-in home screen on the app, at 3014, such as shown in FIG. 3C.

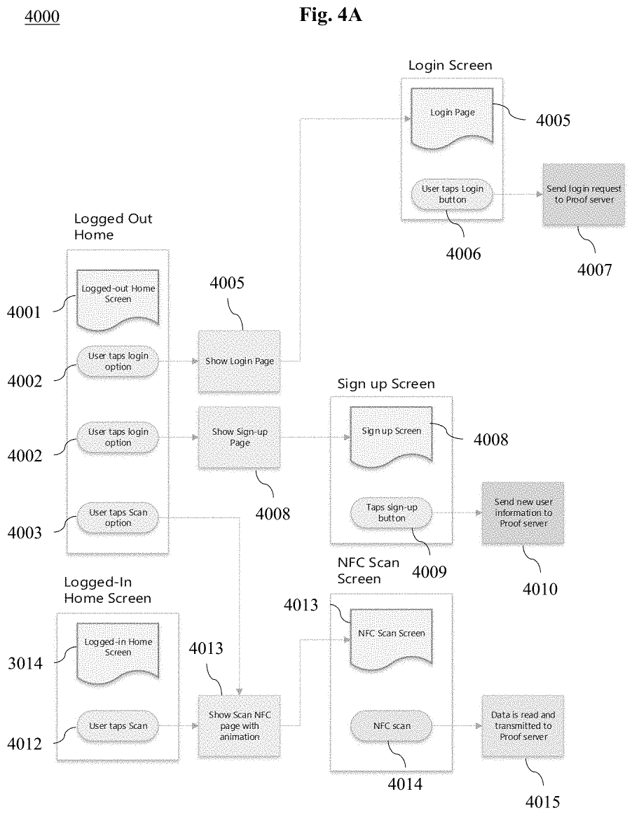

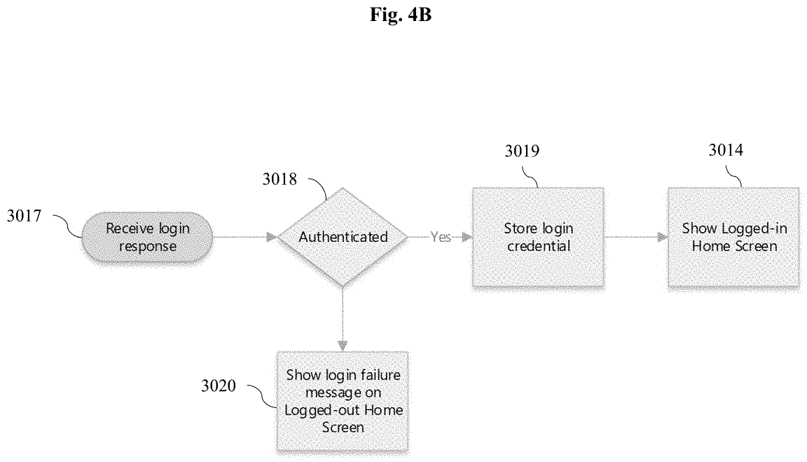

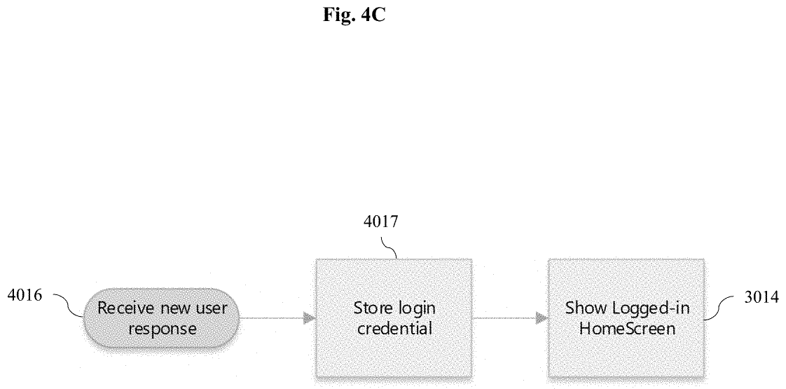

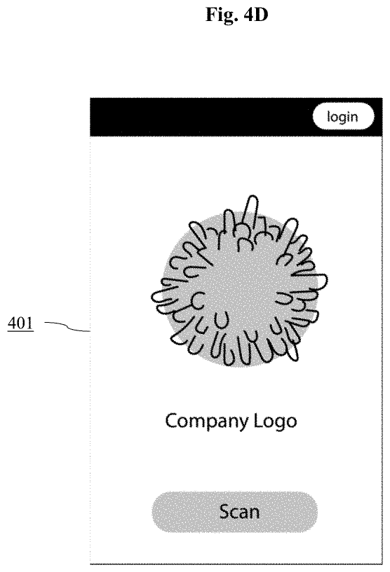

In some embodiments, in order to trigger the database query, the authentication server 110 can initiate a registration, such as via an application navigation process 4000, shown in FIG. 4A. The first time a user logs on to the app using their client device 101, the client device 101 displays a user interface on a display portion of the client device 101 that indicates all users have been logged-out, at 4001. The user interface includes an option, such as a button or a hyperlink, to login, at 4002 (such as shown in a login user interface 401 shown in FIG. 4D). If the user selects this option on the display of the client device 101, the user interface will transition to a login page, at 4005. At the login page, the user can enter their credentials and/or other security information, which will be sent to the authentication server 110 once the user selects to enter the information, at 4006. The login request can be processed by the authentication server 110, at 4007.

Subsequently, returning to FIG. 3B, the authentication server 110 authenticates the user against the registration database, at 3015. The authentication can include single-factor, multi-factor, strong, continuous, digital, and/or the like as desired. The response of this authentication is returned to the client device 101, at 3016.

Turning to FIG. 4B, once the response of this authentication is received at the client device 101, the client device 101 determines whether the authentication was successful or not (decision block 3018). If the user could not be authenticated, the user is notified on the user interface of the client device 101 that indicates all users have been logged-out with an additional message that the login failed, at 3020. Alternatively, if the user was authenticated, their login credentials are stored in the registration database, at 3019. Additionally and/or alternatively, the login credentials can be maintained locally on the client device 101 as a digital value which refers to a record on the authentication server 110. The user is then presented with the logged-in home screen on the user interface, at 3014.

Returning to FIG. 4A, new users can also sign-up, at 4008. For example, once the selects the option on the user interface to login, at 4002, the user interface will transition to a login page, at 4005. Additionally and/or alternatively, this login page can also display an option for new users, such as a hyperlink, to sign-up, at 4008. The user is then redirected to a sign-up screen. This sign-up page can include a form for users to enter their desired credentials to be sent to the authentication server 110, at 4010.

With reference again to FIG. 3B, at the authentication server 110, the new user credentials are received with a sign-up request, at 4010. These credentials are stored in the user registration database, at 3022, for example, in a relational database table that pairs user accounts with their relevant information. In some embodiments, a lookup is made into the registration database to determine the validity of the new credentials, for example, for unique user names, and also to cross-check against any additional security information provided at or after the time of registration. A confirmation is returned to the client device 101, at 3023.

Turning to FIG. 4C, the confirmation from the authentication server 110 is received, at 4016. Optionally, these credentials can be stored on the client device 101, at 4017, such as using a session identifier or unique digital value for associating a record at the authentication server 110 described above. The client device 101 is redirected to the logged-in home screen on the user interface, at 3014.

The product authentication system 100 advantageously leverages the client device 101 to authenticate the product 102. Although the client device 101 can be product agnostic, the client device 101 can scan an NFC-type chip in the product 102 for the authentication server 110 to verify. Stated in another way, assume the product 102 is a high-end luxury handbag. Although the client device 101 does not need to know that the product 102 is a handbag, the product 102 can be embedded with an NFC-type chip that has a unique identifier, for example, from the original handbag manufacturer. For example, the handbag can include a fractional cryptocurrency identifier from the original manufacturer to confirm its authenticity. In some embodiments, any conventional NFC tag can be used. Additionally and/or alternatively, the NFC tag can include a secret asymmetric key and provide a command to sign a cryptographic challenge with that key. In this latter embodiment, there can be a microcontroller disposed in the NFC tag that executes a process to prevent cloning.

This chip can be scanned by the client device 101 in any manner described herein, such as described with reference to FIG. 4A. Turning to FIG. 4A, a logged-out user can select a scan option on the user interface of the app, at 4003. A logged-in user can also select the scan option on their user interface, at 4012. The client device 101 is redirected to the scan home page, at 4013. At the scan home page, the user is prompted to scan the product 102, at 4014. The results of the scan are transmitted to the authentication server 110, at 4015.

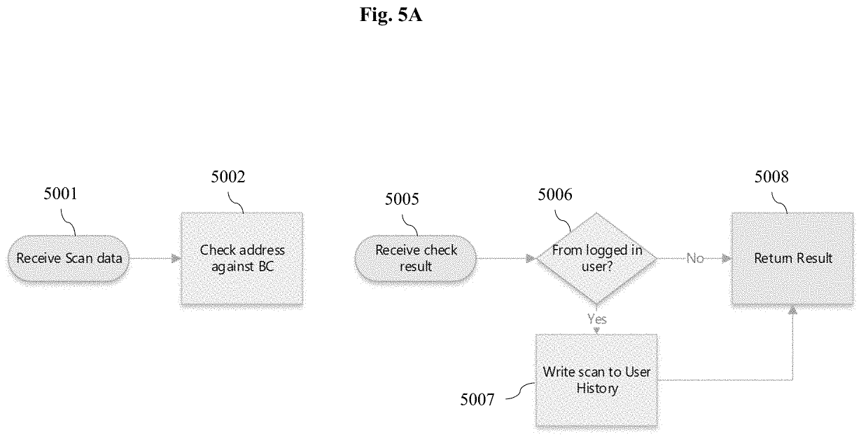

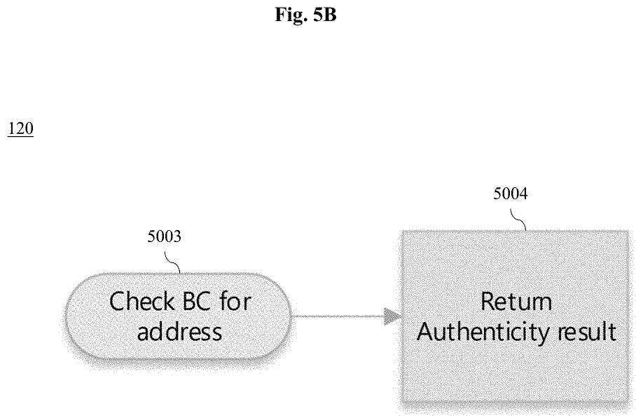

Turning to FIG. 5A, at the authentication server 110, the results of the scan are received, at 5001. The authentication server 110 will check these results against the ledger 120, such as against a Blockchain, at 5002. For example, as shown in FIG. 5B, the results of the scan can be checked against a Blockchain address, at 5003. The Blockchain can represent a digital, ledger of all transactions that can be keyed using a transaction identifier (ID). The transaction ID represents a unique “fingerprint” of a transaction and allows the transaction to be tracked. The results of the lookup are returned to the authentication server 110, at 5004.

With reference again to FIG. 5A, once the authentication server 110 receives the results of the lookup in the ledger 120, at 5005, the authentication server 110 can present the information to the client device 101 based on whether the user has been logged in (decision block 5006), for example, using methods such as previously described. For a logged in user, the results of the scan can be associated with the user in the user registration database, at 5007. In either case, the results are returned to the client device 101, at 5008.

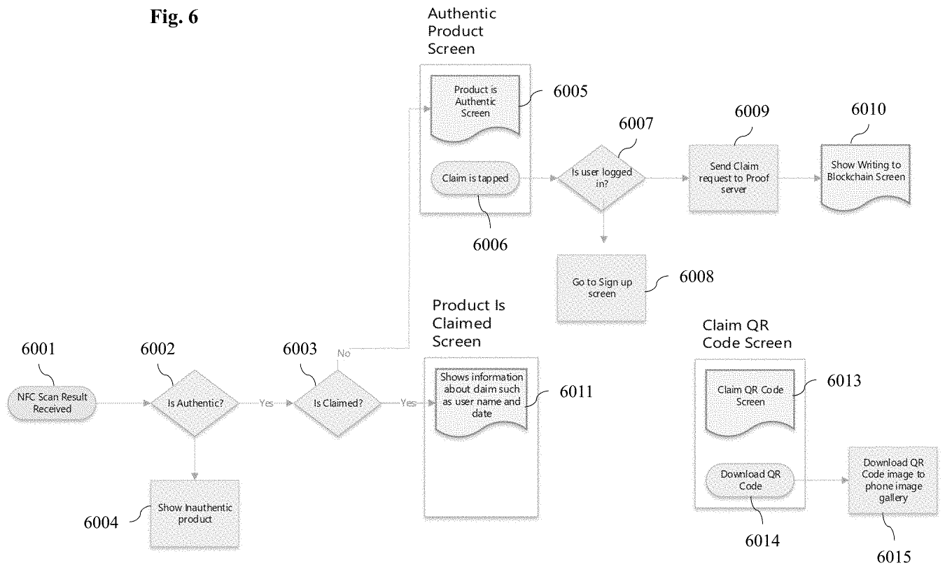

Turning now to FIG. 6, the client device 101 can present digital information about the product 102 once the results are received, at 6001. Specifically, if the product 102 could not be authenticated, the user is notified that the product 102 is likely counterfeit, at 6004. In some embodiments, the authentication of the product includes using the client device 101 to scan a proof chip within the product 102. The client device 101 then relays that information from the proof chip to the authentication server 110, which checks for a blockchain address. If the product was authenticated, based on the blockchain address that was received, the authentication server 110 then determines whether the product 102 has been claimed (decision block 6003). For example, a product can be claimed as recorded to the ledger 120, which claim can be released to allow for subsequent claims. If the product 102 is unclaimed (e.g., no unreleased claim information exists for the product 102), the client device 101 is redirected to a user interface indicating that the product is authenticated, at 6005. The client device 101 also presents the user with an option to claim the product 102, at 6006. If the user selects the option to claim the product 102, the authentication server 110 determines whether the user is logged in (decision block 6007). If the user is not logged in, the user is redirected to do so, at 6008. Alternatively, for logged in users, the request to claim the product 102 is sent to the authentication server 110, at 6009. The user is informed that the claim request is being written to the ledger 120, at 6010.

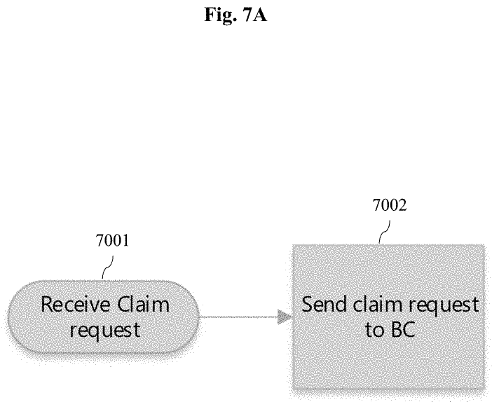

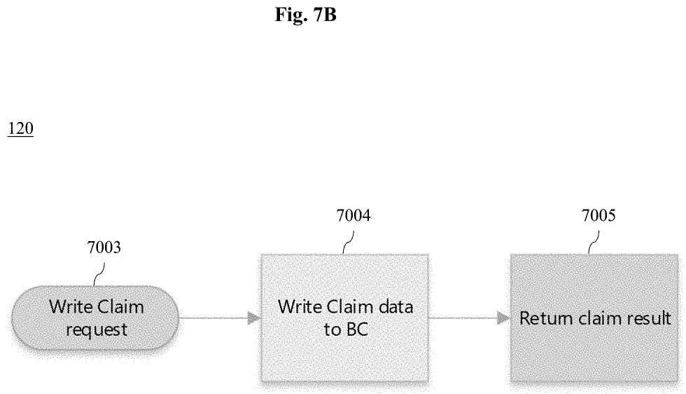

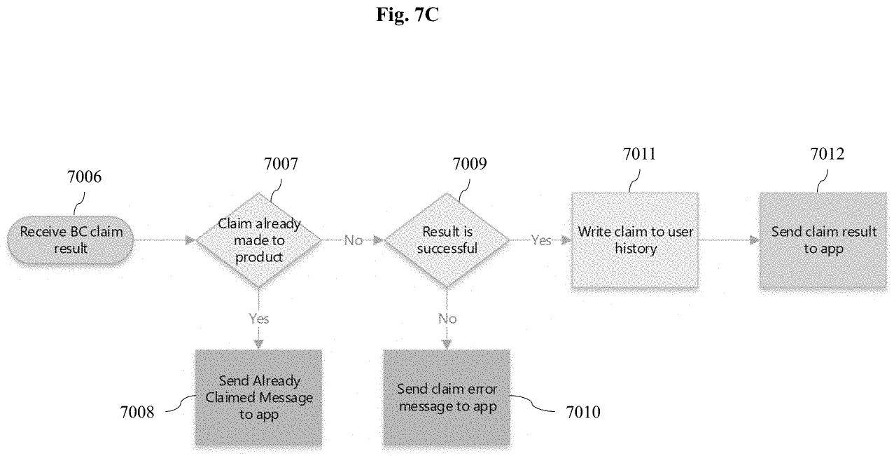

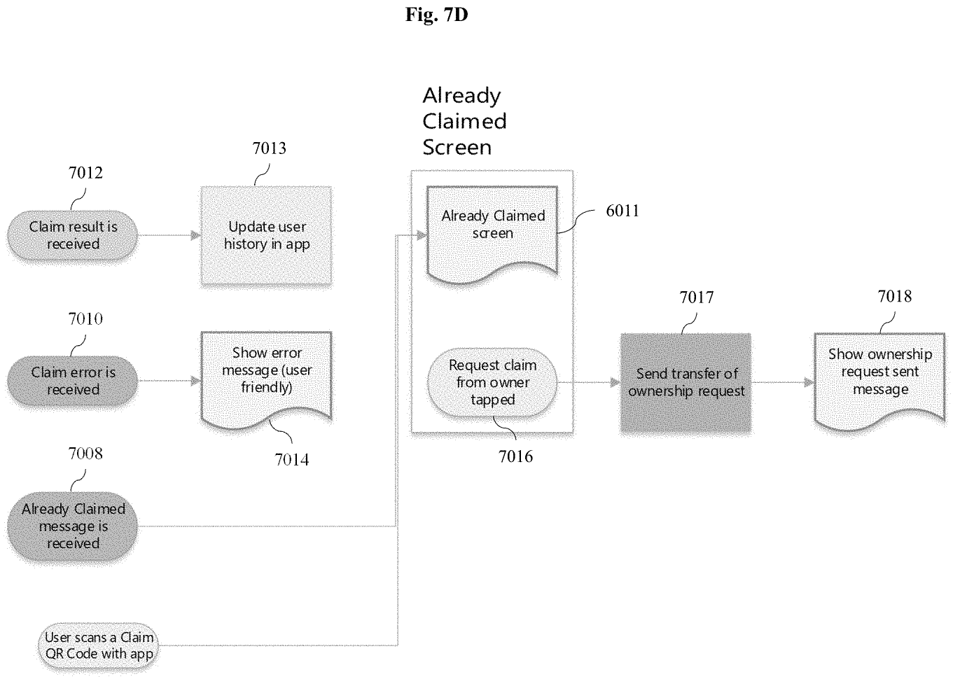

As shown in FIG. 7A, the authentication server 110 receives the request to claim the product 102, at 7001. This claim request is sent to the ledger 120, at 7002. For example, the claim request can include a user identification used on the authentication server 110 (or a hash-encrypted identifier) and optional user information. Turning to FIG. 7B, the request to claim the product 102 is written to the ledger 120. Specifically, the claim data is written as a transaction to the ledger 120, at 7004. The result of the transaction is returned to the authentications server 110, at 7005. In some embodiments, the result of the transaction can include a success/failure flag and/or a blockchain address of the information written.

Turning to FIG. 7C, once the authentication server 110 receives the result of the transaction, at 7006, the authentication server 110 can determine whether a claim has already been made to the product 102 (decision block 7007). If a claim has already been made, the user is notified on the client device 101, at 7008. This advantageously alerts the user that the product 102 does not have a clean title or is currently owned—digitally—by another user—for example, the seller. If a claim is not already made to the product 102—such as for a new product, then the authentication server 110 determines whether the claim result is successful (decision block 7009), for example, based on prior unreleased claim information. If unsuccessful, a claim error is sent to the client device 101, at 7010. If the result is successful, the claim is written to the user registration database, at 7011. The claim result is sent to the client device 101, at 7012.

Depending on the result of the claim result, the client device 101 can notify the users in any manner described herein, such as shown in FIG. 7D. For example, when the claim result is received, the claim can also be updated in a history section of the app of the client device 101, at 7013. If the claim error was received, at 7010, then the error can be displayed on the user interface of the client device 101, at 7014.

In the event that the claim has already been made, at 7008, the client device 101 can present a user interface that shows the product 102 has already been claimed, at 6011 (also shown in FIG. 6). However, the product authentication system 100 can advantageously streamline the transfer of ownership of the product 102 from the current owner—such as the seller—to the consumer. For example, an option to request the claim from the current owner can be presented on the user interface. If the user selects this option on their client device 101, at 7016, the transfer of ownership request is sent to the authentication server 110, at 7017. The user is informed that the ownership request is being sent, at 7018.

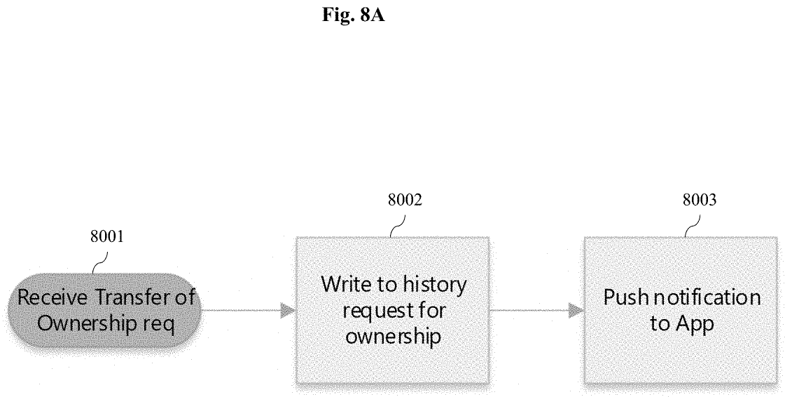

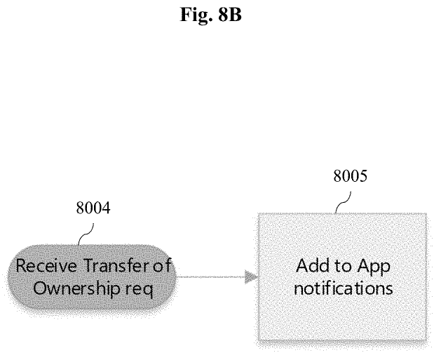

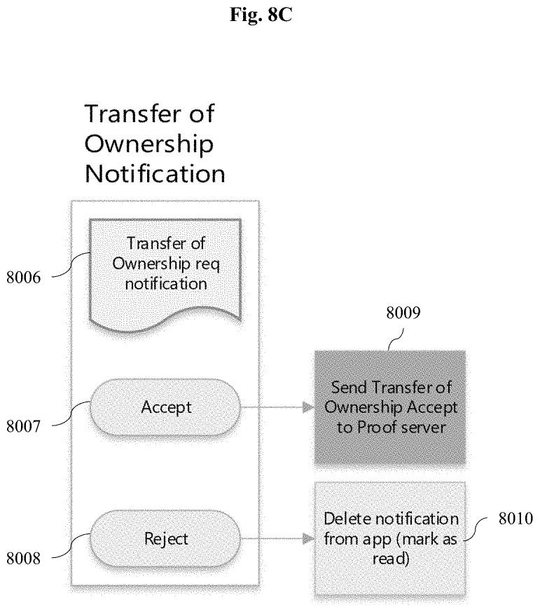

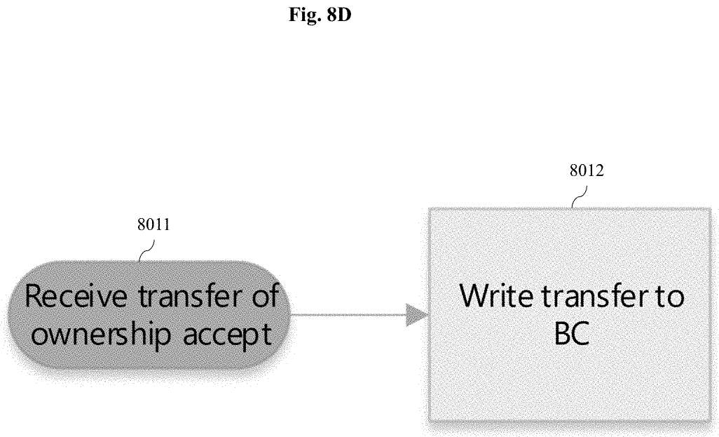

With reference to FIG. 8A, the transfer of ownership request is received at the authentication server 110, at 8001. This request can be written to the user registration database, at 8002. A notification can be pushed to the app on the client device 101 that the ownership transfer has been requested, at 8003. In some embodiments, turning to FIG. 8B, the transfer of ownership request can also be received at the client device 101, at 8004. The transfer of ownership request is then added to a notifications section of the app on the client device 101, at 8005.

The current owner of the product 102 can receive the request to transfer the ownership of the product 102 on their client device 101, for example, as shown in FIG. 8C. With reference to FIG. 8C, the transfer of ownership request can be provided as a notification and/or a unique screen on the user interface of the client device 101 that the current owner can see, at 8006. In some embodiments, the transfer of ownership request can additionally provide the current owner with an option to accept, at 8007, or reject, at 8008. If the current owner selects the reject option, the notification is deleted from the app on the client device 101 of the current owner and/or marked as read, at 8010. If the current owner selects the accept option, then the transfer of ownership acceptance is transmitted to the authentication server 110, at 8009.

Turning to FIG. 8D, the transfer of ownership acceptance is received by the authentication server 110, at 8011. This acceptance is written to the ledger 120, at 8012. The ledger 120 can advantageously manage not only the authentication of the product 102, but also the enforcement of the digital transaction through the smart contract of the ledger 120.

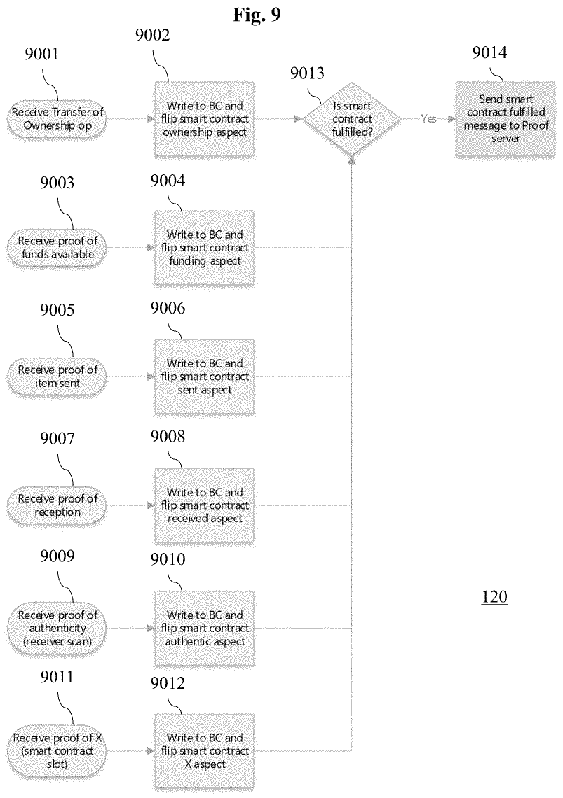

In other words, the product authentication system 100 can both authenticate the product 102 and manage the transaction of associated fees related to the sale of the product 102. For example, turning to FIG. 9, the ledger 120 processes the acceptance of the transfer of ownership request, at 9001. Specifically, a new transaction and associated transaction ID for the transfer of ownership can be written to the ledger 120, at 9002. The relevant ownership of the transaction is corrected to reflect that the current owner is now the customer.

The ledger 120 can also confirm that the customer has proof of funds available, at 9003; that the seller/current owner has sent the item, at 9005; that the customer has received the product, at 9007; that the product 102 has been identified as an authentic product, at 9009; and any other proof, at 9011. Each of these data pieces can be written to the ledger 120, at 9004, 9006, 9008, 9010, and 9012, respectively. It should be understood that any items of proof can be required based on any predetermined criteria as desired. Once these items are proof are received, the ledger 120 can determine whether the smart contract for the transaction is fulfilled (decision block 9013). The results of satisfying each item of proof is sent to the authentication server 110, at 9014.

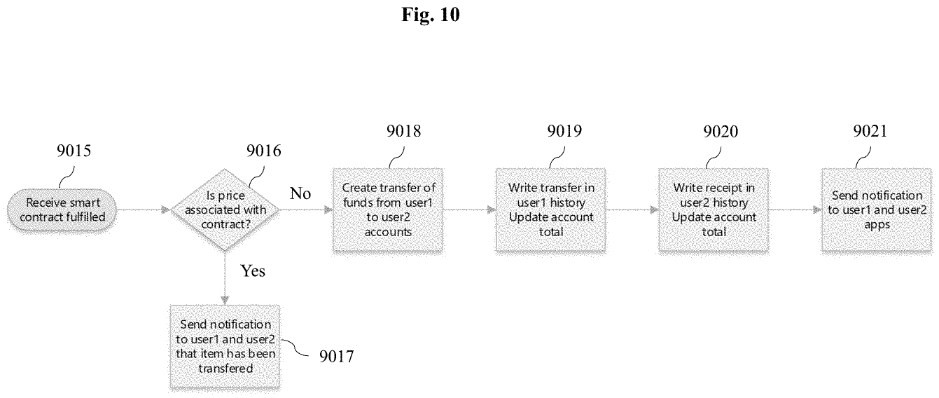

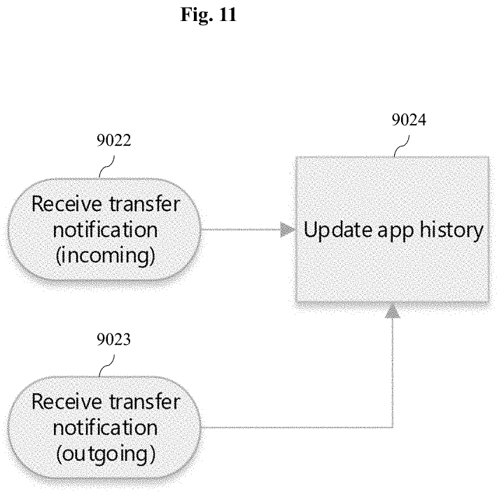

With reference to FIG. 10, the authentication server 110 receives the results of fulfilling the smart contract, at 9015. The authentication server 110 determines whether the transfer of funds was executed through the smart contract (decision block 9016) to establish whether the transaction is complete. If the smart contract includes an associated price, then a notification is sent to both the customer and the seller on their client device 101 that the product 102 has been sold and the transaction is complete, at 9017. If no price is associated, the authentication server 110 can also initiate the transfer of funds from the customer to the seller, at 9018. In some embodiments, the transfer of funds can occur at a third-party, such as a transfer from a user's bank account that has been connected to their user account on the authentication server 110, conversion of funds into cryptocurrency or a digital wallet, and/or direct transfer from a buyer's connected bank account to a seller's connected bank account. In the event a holding account is used, a transfer of funds is considered complete when the funds are transferred from the holding account into the seller's account. Once the transfer of funds is initiated, the transfer of the funds from the customer is written to the user registration database, at 9019, and their account total is updated. The receipt is written to the account of the seller, at 9020, and their account total is updated. These notifications are both received, at 9022 and 9023, respectively, as shown in FIG. 11. The history for both users is updated in their app on their client device, at 9024. Both users are notified, at 9021.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A method for authenticating a product and managing the digital transaction of the product comprising:
providing a near-field communication tag to be disposed within the product, wherein the near-field communication tag is scannable by one or more client devices and includes a unique identifier;
receiving an electronic stream of data at an authentication server resulting from a scan of the near-field communication tag of the product via one or more client devices, each client device having a near-field communication antenna and executing a software-based application having a graphical user interface on a display thereof;
checking the received electronic stream of data against a distributed ledger that provides at least one layer of smart contracts and a second layer for settlements;
returning results of said checking to the one or more client devices.

2. The method of claim 1, wherein said checking the received electronic stream of data against the distributed ledger comprises checking the distributed ledger for a blockchain address associated with the received electronic stream of data.

3. The method of claim 1, wherein said returning results of said checking to the one or more client devices comprises notifying the user if the product is likely counterfeit.

4. The method of claim 1, wherein said checking the received electronic stream of data against the distributed ledger comprises determining whether the product is unclaimed.

5. The method of claim 4, further comprising providing an option to claim the product when said determining yields no unreleased claim information for the product as recorded on the distributed ledger.

6. The method of claim 5, further comprising receiving a request to claim the product based on a selection of the provided option, the request to claim the product including a has-encrypted identifier of a user that submitted the request.

7. The method of claim 4, further comprising providing an option to request a transfer of the claim to the product when said determining yields an unreleased claim for the product as recorded on the distributed ledger.

8. The method of claim 7, further comprising determining a proof of funds from the distributed ledger.

9. The method of claim 1, wherein said checking the received electronic stream of data against the distributed ledger comprises checking the received electronic stream of data against an Algorand Blockchain.

10. A non-transitory computer medium including instructions stored thereupon, the instructions being executable by a processor for authenticating a product and managing the digital transaction of the product, the instructions comprising:
program code for providing a near-field communication tag to be disposed within the product, wherein the near-field communication tag is scannable by one or more client devices and includes a unique identifier;
program code for receiving an electronic stream of data at an authentication server resulting from a scan of the near-field communication tag of the product via one or more client devices, each client device having a near-field communication antenna and executing a software-based application having a graphical user interface on a display thereof;
program code for checking the received electronic stream of data against a distributed ledger that provides at least one layer of smart contracts and a second layer for settlements;
program code for returning results of said checking to the one or more client devices.

11. The non-transitory computer medium of claim 10, wherein said checking the received electronic stream of data against the distributed ledger comprises checking the distributed ledger for a blockchain address associated with the received electronic stream of data.

12. The non-transitory computer medium of claim 10, wherein said returning results of said checking to the one or more client devices comprises notifying the user if the product is likely counterfeit.

13. The non-transitory computer medium of claim 10, wherein said checking the received electronic stream of data against the distributed ledger comprises determining whether the product is unclaimed.

14. The non-transitory computer medium of claim 13, further comprising program code for providing an option to claim the product when said determining yields no unreleased claim information for the product as recorded on the distributed ledger.

15. The non-transitory computer medium of claim 14, further comprising program code for receiving a request to claim the product based on a selection of the provided option, the request to claim the product including a has-encrypted identifier of a user that submitted the request.

16. The non-transitory computer medium of claim 13, further comprising program code for providing an option to request a transfer of the claim to the product when said determining yields an unreleased claim for the product as recorded on the distributed ledger.

17. The non-transitory computer medium of claim 16, further comprising program code for determining a proof of funds from the distributed ledger.

18. The non-transitory computer medium of claim 10, wherein said checking the received electronic stream of data against the distributed ledger comprises checking the received electronic stream of data against an Algorand Blockchain.

19. A system for authenticating a product and managing the digital transaction of the product comprising:
one or more client devices, each client device having a near-field communication antenna, each device executing a software-based application and having a graphical user interface on a display thereof;
an authentication server in operable communication with the one or more clients over a data network;
a near-field communication tag disposed within the product and being scannable by the one or more client devices, electronics results of a scan being provided to the authentication server for authentication of the product; and
a distributed ledger that provides at least one layer of smart contracts and a second layer for settlements.

20. The system of claim 1, wherein said distributed ledger includes an Algorand Blockchain.
